(19) United States
(12) Patent Application Publication
(10) Pub. No.: US 2011/0168686 A1
(43) Pub. Date: Jul. 14, 2011

(54) CARTRIDGE SOLDERING IRON ASSEMBLY AND A SOLDERING IRON

(75) Inventor: Joseph Zhuo LI, Douglaston, NY (US)

(73) Assignee: Beijing Shimaichuang Industrial Co., Ltd., Beijing (CN)

(21) Appl. No.: 13/004,394

(22) Filed: Jan. 11, 2011

(30) Foreign Application Priority Data
Jan. 11, 2010 (CN) 201020000377.4

(51) Int. Cl. H05B 1/00

(52) U.S. Cl. 219/201

(57) ABSTRACT

An approach is provided for adaptively indicating users to operate a cartridge-type soldering iron with a proper setting temperature. The cartridge soldering iron assembly includes a sleeve and a color indicator. The sleeve coupled to a connector and a tip. The color indicator indicates a setting temperature of the tip, is disposed on an outer surface of the sleeve and is associated with the sleeve at a predetermined position.

This application claims priority benefit under 35 USC 119 of a foreign patent application, Ser. No. 201020000377.4 CHINA, filed on Jan. 11, 2010 which are hereby incorporated by reference.

### FIELD OF THE INVENTION

Embodiments of the invention relate to a cartridge soldering iron assembly and an associated soldering iron.

### BACKGROUND OF THE INVENTION

In the manufacturing process of electronic equipment, the soldering of electronic components is a very important technique. Also, as an important soldering tool, the soldering iron is widely utilized in this production process.

At present, the soldering irons used in the field could be divided into two types: one is the traditional Directly-Heated Soldering Iron, which adopts a ceramic heater. Under the rated voltage, the tip body stores heat energy according to the power settled by the resistance, current and voltage applied on the heating wire, and the heater transmits the thermal energy to the soldering iron tip, subsequently, the thermal energy is transmitted to the solder joint by the temperature difference generated when the tip touches the soldered object.

Another type is the Induction Soldering Iron, which employs a heating method of High-Frequency Induction Heating under the rated voltage/frequency, the magnetic materials generates the heat affected by a high-frequency magnetic field, and the soldering tip heater transfers the thermal energy to the soldering iron tip, and subsequently, the thermal energy is transferred to the solder joint by the temperature difference generated when the soldering tip touches the soldered object.

During the soldering process, along with a drop of the temperature on the soldering iron tip, the built-in temperature sensor captures the variation in temperature, and provides the compensated energy to the tip by the controlling circuit of the heater, therefore, the automation of temperature control is achieved. In the adoption of the more advanced inductive heating technology, the thermal energy transfer is no longer controlled by the temperature sensor devices, but by the application of the physical properties of the magnetic materials' Curie point themselves. Therefore, such temperature self regulated soldering technology has been applied broadly.

No matter which type of soldering iron is selected, the temperature of the soldering iron tip is always the key factor in production. As for product quality, in the production process, it is of vital importance to identify temperature fast and use the correct soldering apparatus at the right temperature.

In order to solve this technical problem, as for the above-mentioned first type of the soldering iron, currently adopting a ceramic heater with a temperature display, it is common for the operator to set the temperature by adjusting the temperature setting on the soldering station according to regulations, and then production management needs to check whether the temperature set on the soldering stations are correct or not. However, the temperature of the soldering iron tip cannot be ascertained directly from the soldering iron, held by the workers.

However, as for the aforesaid second type of the soldering iron, no temperature display and adjusting device is set on the soldering station, since the temperature setting of the soldering tip depends upon the advanced-embedded heater materials. The operators need to select the correct temperature of the tip according to the regulations. Since the managers cannot ascertain the temperature setting of the tip by looking at it, the only way to verify the temperature is to look at the part number by removing the tip from the soldering iron handle.

Generally, cartridge soldering iron tips with the same geometrical shape have at least three different temperature series. It is hard to distinguish them from the shape and package. Therefore, confusion may occur during use or during selection of the soldering apparatus.

Thus it can be seen that, referring to this technical problem, people put more emphasis upon the effective control of the temperature, but ignore the issue of fast identification of the temperature. However, in fact, fast temperature identification is the most immediate and effective way to ascertain whether the operator is using the soldering iron at the correct temperature.

### SOME EXEMPLARY EMBODIMENTS

These and other needs are addressed by the present invention, in which an approach is provided for adaptively indicating users to operate a soldering iron with a proper setting temperature.

According to one aspect of an embodiment of the present invention, a cartridge soldering iron assembly comprises a sleeve and a color indicator. The sleeve has a proximal end and a distal end, the distal end is adapted to couple to a tip. The color indicator indicates the setting temperature of the tip, is disposed on an outer surface of the sleeve and is associated with the sleeve at a predetermined position between the proximal and distal ends.

According to another aspect of an embodiment of the present invention, a cartridge soldering iron assembly comprises a sleeve and a color indicator. The sleeve is connected to a tip, and has a holding portion and an exposing portion. The holding portion of the sleeve is adapted to insert into a handle. The color indicator is disposed adjacent to the handle and is disposed on the exposing portion of the sleeve.

According to yet another aspect of an embodiment of the present invention, a soldering iron comprises a cartridge soldering iron assembly and a handle. The cartridge soldering iron assembly comprises a holding portion, an exposing portion and a color indicator. The handle is adapted to receive the holding portion of the cartridge soldering iron assembly. The color indicator is used for indicating a setting temperature of the cartridge soldering iron assembly and is disposed on the exposing portion of an outer surface of the cartridge soldering iron assembly.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various respects, all without departing from the spirit and scope of the invention. Accordingly, the drawings and description are to be regarded as illustrative, and not as restrictive.

### BRIEF DESCRIPTIONS OF THE DRAWINGS

FIG. 1 is an illustration of an exemplary structure of a cartridge soldering iron assembly according to an embodiment of the present invention.

FIG. 2 is a partially exemplary illustration of a soldering iron according an embodiment of the present invention.

FIG. 3 is an exemplary illustration of a soldering iron according to an embodiment of the present invention.

### DESCRIPTION OF THE PREFERRED EMBODIMENT

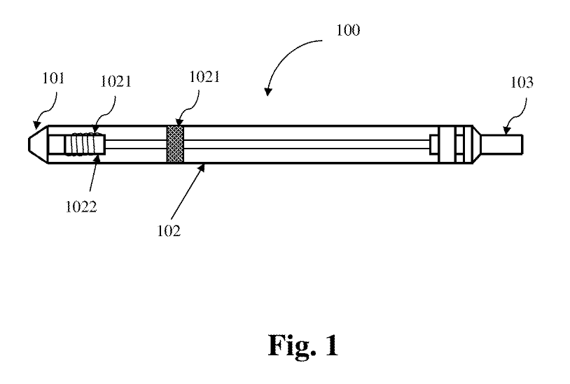

With reference to FIG. 1, FIG. 1 is an illustration of an exemplary structure of a cartridge soldering iron assembly according to an embodiment of the present invention. In this example, a cartridge soldering iron assembly 100 comprises a tip 101, a sleeve 102, a connector 103 and a color indicator 111. The sleeve 102 has a proximal end and a distal end. The proximal end is adapted to couple to the connector 103 and the distal end is adapted to couple to the tip 101. The sleeve 102 further comprises an inducting coil 1021 and a heating mechanism 1022. The inducting coil 1021 and the heating mechanism 1022 are disposed inside the sleeve 102. In this example, the connector 103 may be an electric plug or a socket that connects to an external power source, which provides required power for operating the cartridge soldering iron assembly.

The color indicator 111 indicates a setting temperature of the tip 101, is disposed on an outer surface of the sleeve 102 and is associated with the sleeve 102 at a predetermined position between the proximal and distal ends. The setting temperature is an operative temperature of the tip 101.

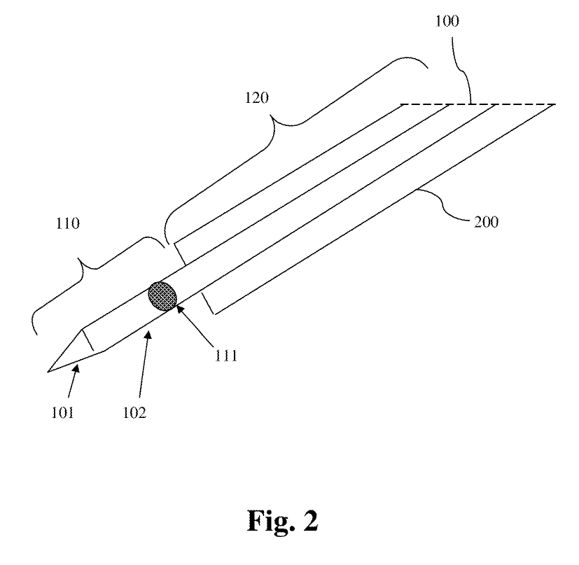

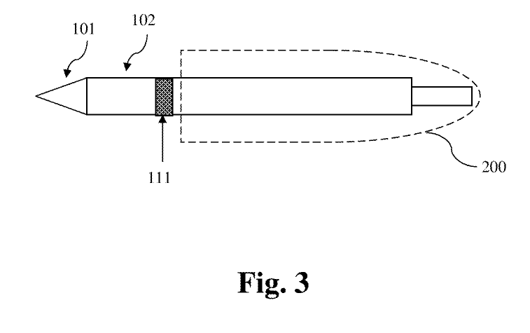

With reference to FIGS. 2 and 3, FIG. 2 is an illustration of a partially exemplary of a soldering iron according to an embodiment of the present invention. FIG. 3 is an illustration of an exemplary of soldering iron according to an embodiment of the present invention. A soldering iron is provided and is formed by a cartridge soldering iron assembly 100 and a handle 200. The cartridge soldering iron assembly 100 comprises a tip 101, a sleeve 102 and a color indicator 111. The sleeve 102 has a proximal end and a distal end. The proximal end is adapted to couple to the connector 103 and the distal end adapted to couple to the tip 101.

As shown in FIG. 2, in this example, the sleeve 102 of the cartridge soldering iron assembly 100 is defined into two portions (i.e., a holding portion 110 and an exposing portion 120). The holding portion 110 of the sleeve 102 is adapted to insert into the handle 200. The color indicator 111 is disposed adjacent to the handle 200 and is disposed on the exposing portion 120. In other words, the exposing portion 120 is formed by a part nearby the distal end of the sleeve 102 and tip 101, the handle 200 may have a hole (not shown) and is adapted to receive the holding portion 110.

As shown in FIG. 3, in this example, a color indicator 111 is disposed on an outer surface of a sleeve 102 between a tip 101 and a handle 200. Also, due to the high temperature of the tip 101, the color indicator 111 is optimally disposed nearby the handle 200, so as that the color indicator 111 is far away from the tip 101.

According to various embodiments of the invention, the color indicator 111 is mounted on an outer surface of the sleeve 102 for indicating a setting temperature of the tip 101, and can be or has any color. Each color is corresponded to a different setting temperature of the tip 101. For example, yellow color of the color indicator 111 refers to the tip 101 that has 300° C. of its setting temperature, and red color of the color indicator 111 refers to the tip 101 that has 400° C. of its setting temperature. A warmer color, for example, represents higher setting temperature of the tip 101.

The color indicator 111 can be made from various forms and materials, for example, The color indicator 111 may be formed by painting the colored heat-resisting materials on the outer surface of the exposing portion 120, or may be a colored heat shrinkable sleeve that attachable wears on the sleeve 102 of the cartridge soldering iron assembly 100. Further, one of ordinary skill in the art would recognize that the shape of the color indicator 111 can be many kinds, such as ring-shaped, strip-shaped or block-shaped.

Accordingly, since the color indicator is located on the outer surface of the sleeve, the setting temperature of the soldering iron can be easily indentified by the color of the color indicator. Further, a package, an order list, a data sheet or a delivering document could use such color indicator as an identified symbol or label to improve the distinguishability in the manufacturing or delivering processes.

During typical operation of the soldering apparatus of embodiments of the present invention, not only helps a person to select proper types of the cartridge soldering iron, but also helps an administrator in processing management. The administrator can easily recognize operating soldering irons from the exposed color indicators, and thereby productivity and quality are significantly improved.

While the invention has been described in connection with a number of embodiments and implementations, the invention is not so limited but covers various modifications and equivalent, which fall within the purview of the appended claims. Although features of the invention are expresses in certain combinations among the claims, it is contemplated that these features can be arranged in any combination and order.

What is claimed is:

1. A cartridge soldering iron assembly comprising
a sleeve having a proximal end and a distal end, wherein the distal end is adapted to couple to a tip; and
a color indicator indicating a setting temperature of the tip, being disposed on an outer surface of the sleeve and being associated with the sleeve at a predetermined position between the proximal and distal ends.

2. The cartridge soldering iron assembly as claimed in claim 1, wherein the tip and a part of the sleeve forms an exposing portion when the sleeve is inserted into a handle.

3. The cartridge soldering iron assembly as claimed in claim 2, wherein the color indicator is mounted on an outer surface and the exposing portion of the sleeve.

4. The cartridge soldering iron assembly as claimed in claim 3, wherein the color indicator on the exposing portion is located nearby the handle and is far away from the tip.

5. A cartridge soldering iron assembly comprising
a sleeve being connected to a tip and having a holding portion and an exposing portion, wherein the holding portion is adapted to insert into a handle; and
a color indicator being used for indicating a setting temperature of the tip, being disposed on the exposing portion and being disposed adjacent to the handle.

6. The cartridge soldering iron assembly as claimed in claim 5, wherein the color indicator is formed by painting the colored heat-resisting materials on an outer surface of the exposing portion.

7. The cartridge soldering iron assembly as claimed in claim 5, wherein the color indicator is formed by wearing a colored heat shrinkable sleeve on the exposing portion of the sleeve.

8. The cartridge soldering iron assembly as claimed in claim 5, wherein the color indicator is in a line-shaped, a ring-shaped or a block-shaped.

9. The cartridge soldering iron assembly as claimed in claim 5, wherein the color indicator has a color that is corresponded to the setting temperature of the tip.

10. A soldering iron comprising
a cartridge soldering iron assembly comprising a holding portion, an exposing portion and a color indicator; and
a handle being adapted to receive the holding portion of the cartridge soldering iron assembly, wherein the color indicator is used for indicating a setting temperature of the cartridge soldering iron assembly and is disposed on the exposing portion of an outer surface of the cartridge soldering iron assembly.

11. The soldering iron as claimed in claim 10, wherein the color indicator is disposed adjacent to the handle.

12. The soldering iron as claimed in claim 10, wherein the color indicator in a line-shaped, a ring-shaped or a block-shaped.

13. The soldering iron as claimed in claim 10, wherein the cartridge soldering iron assembly further comprises a sleeve and a tip, and a part of the sleeve and the tip forms the exposing portion.

14. The soldering iron as claimed in claim 13, wherein the color indicator is formed by painting the colored heat-resisting materials on an outer surface of the exposing portion of the sleeve.

15. The soldering iron as claimed in claim 13, wherein the color indicator is formed by wearing a colored heat shrinkable sleeve on the exposing portion of the sleeve.

16. The soldering iron as claimed in claim 13, wherein the color indicator has a color that is corresponded to the setting temperature of the tip.
